(19) United States
(12) Patent Application Publication
(10) Pub. No.: US 2005/0099301 A1
(43) Pub. Date: May 12, 2005

(54) Method for fitting a transponder to a metal body, and a transponder module for carrying out the method

(76) Inventor: Werner Bloch, Eislingen (DE)

Correspondence Address: Joseph W. Berenato, III;Liniak, Berenato & White, LLC, Suite 240, 6550 Rock Spring Drive, Bethesda, MD, 20817, US

(21) Appl. No.: 10/702,037

(22) Filed: Nov. 6, 2003

(51) Int. Cl. G08B 13/14

(52) U.S. Cl. 340/572.7; 340/572.8; 257/679; 257/787; 438/106; 343/872; 342/51

(57) ABSTRACT

A method for fitting a transponder with a chip and a coil to a metal body is disclosed. The coil is wound in the form of a bar and is electrically connected at its ends to the electrical connections of the chip, forming a transponder. The transponder formed is introduced in its entirety into a cavity in the metal body in such a manner that the coil axis (X) lies parallel to the metal surface. At least part of the coil is positioned in the region of a window in the metal body.

The present invention relates to a method for fitting a transponder with a chip and a coil to a metal body. The invention furthermore relates to a transponder module which is particularly highly suitable for carrying out the method.

Transponders comprising a chip and a coil have been known for a long time and are used in different fields where non-contacting data interchange is intended to take place between the chip of the transponder and a reader. The data interchange in this case takes place via alternating electromagnetic fields, for which purpose the transponder has an appropriate antenna in the form of a coil. The transponder technique is used, for example, for smart cards which operate without any contact being made. In addition to application fields such as these in environments where there are largely no disturbances, fields of use also exist in which the transponders are used directly on electrically conductive surfaces, in particular metallic surfaces. This is frequently the case in automation, when transponders are used for object identification.

In this context DE 196 22 387 A1 proposes that the coil be wound on a flat mounting body and this mounting body be fitted to the surface of the metal body via appropriate attachment devices such that the axis of the coil lies approximately parallel to the surface of the metal body.

This method has the problem that the transponder is sensitive to mechanical and thermal loads, vibration, etc. during operation.

The object of the invention is thus to specify a method by means of which a transponder can be fitted to a metal body in a simple manner such that it is well protected. Furthermore, it is intended to specify a transponder module which is suitable for carrying out the method.

According to the invention, this object is achieved in that the coil is wound in the form of a bar and is electrically connected at its ends to the electrical connections of the chip, forming a transponder, and the transponder formed in this way is introduced in its entirety into a cavity in the metal body in such a manner that the coil axis lies parallel to the metal surface, and at least part of the coil is positioned in the region of a window in the metal body.

Since the transponder coil is in the form of a rod and is arranged in the region of the window in the metal body, a magnetic field which is produced by the transmission coil of an appropriate RF (radio frequency) reader can excite the transponder coil through the window, so that the chip of the transponder can be read and can also be written to. The transponder is in this case protected against damage, since the transponder is embedded in the cavity.

One preferred embodiment of the invention provides that the transponder is introduced into the cavity in such a manner that it is completely surrounded by metal except for the region of the window. In this case, it is sufficient for the window in the metal body to be in the form of a narrow gap whose length may be shorter than the coil and/or whose width may also be narrower than the coil. This means that the transponder is very well protected against damage. By way of example, the transponder can be introduced into a hole running parallel to the surface of the metal body, in which case it is then completely surrounded by metal, except for the hole opening and the window opening.

Alternatively, it is possible to introduce the transponder into a cavity in the form of a groove in the surface of the metal body. However, with this embodiment, care must be taken to ensure that the groove is sufficiently deep that the transponder does not project above the surface of the metal body.

In order to further increase protection for the transponder, one preferred embodiment of the invention provides that the transponder is embedded in an elastic material forming a transponder module before being introduced into the cavity in the metal body. This elastic material is preferably a soft plastic material, in particular silicone or polyurethane, which protects the transponder against thermomechanical stresses, the influence of shocks, vibration and mechanical impacts.

In addition, it is possible to introduce the transponder module into a sleeve composed of a non-metallic material such as glass or plastic, which firstly offers additional protection and secondly also forms a closed unit from the transponder module which can easily be introduced into the cavity in the metal body, and can be positioned therein.

Particularly in the situation where the cavity is in the form of a hole, the sleeve may in this case expediently have a tubular shape, in which case the transponder is then introduced into the sleeve such that the coil axis runs parallel to the tube axis and is thus aligned in a defined manner with respect to the sleeve.

In the situation where a sleeve such as this is used, the transponder comprising the chip and coil can first of all be introduced into the sleeve, with the sleeve then being encapsulated with an elastic material: Alternatively, it is possible to first of all embed the transponder into the elastic material, and then to provide it with the sleeve. Apart from this, the tubular sleeve may be designed to be open or else closed at each of its axial ends.

One development of the present invention provides that the cavity in the metal body is encapsulated with a non-metallic elastic material once the transponder or the transporter module has been introduced, in which case a plastic material, for example, an epoxy resin, can expediently be used as the encapsulation material. The encapsulation material is in this case preferably harder than the elastic material in which the transponder is embedded and/or with which the sleeve is filled, since it is essentially intended to provide the transponder with protection against mechanical damage. The encapsulation material may in this case be the same colour as the metal body, so that the cavity cannot easily be identified with the transponder introduced in it, thus offering additional protection against malicious damage.

With regard to further advantageous refinements of the invention, reference is made to the dependent claims and to the following description of an exemplary embodiment, referring to the attached drawing, in which:

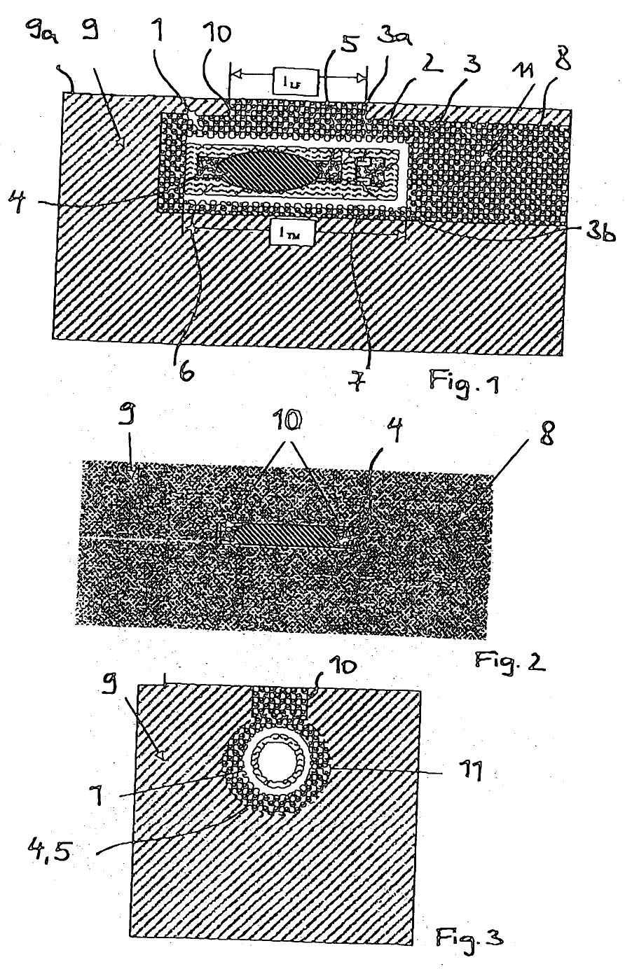

FIG. 1 shows a section view of a transponder module, according to the present invention, which has been introduced into a hole in a metal body,

FIG. 2 shows a plan view of the arrangement from FIG. 1,

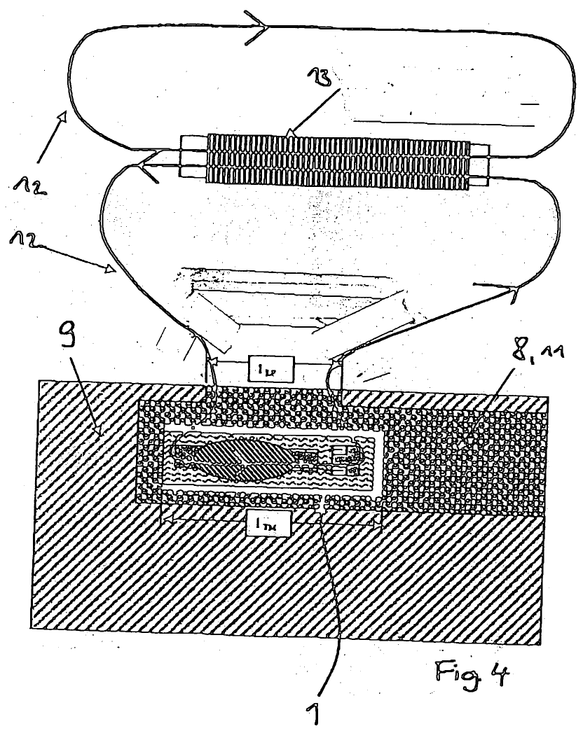

FIG. 3 shows a side view of the arrangement from FIG. 1, and

FIG. 4 shows the arrangement in FIG. 1 with, in addition, a transmission coil of an RF reader, in operation.

FIGS. 1 to 3 show a transponder module 1 according to the present invention. This transponder module 1 has a transponder 2 comprising a chip 3 and a coil 4 which is wound on a ferrite core 5 in the form of a bar and is electrically connected at their end regions to the electrical connections 3a, 3b—also referred to as bond pads—of the chip 3. The transponder 2 is introduced into a tubular sleeve 7, which is closed at one of its axial ends, is composed of glass or plastic, and is filled with an elastic material 6, such as silicone or polyurethane. The transponder 2 is in this case positioned in the sleeve 6 such that the longitudinal axis of the coil 4, and of the ferrite core 5, lies parallel to the longitudinal axis of the sleeve 7.

The transponder module 1 formed in this way is introduced into a cavity 8 in the metal body 9, which is in the form of a hole lying parallel to the surface 9a of the metal body 9 with the hole 8 having a window 10, in the form of a gap, which is open towards the surface 9a of the metal body 9. The transponder module 1 is in this case positioned in the hole 8 such that the transponder coil 4 is located in the region of the window 10, as can be seen particularly well in the plan view in FIG. 2 and, furthermore, the transponder module 1, and hence the coil 4, as well, are aligned approximately parallel to the surface 9a of the metal body 9.

The hole 8 in the metal body 9 with the transponder module 1 positioned in it is filled with an encapsulation material 11, which is preferably harder than the elastic material 6 in which the transponder 2 is embedded. By way of example, the encapsulation material 11 may be an epoxy resin.

Apart from this, FIGS. 1 to 3 show well that the length l_{TM} of the transponder module 1 is greater than the length l_{LF} of the reading window 10, and is also wider. Specifically, the dimensions of the read window 10 are chosen such that they are just sufficiently large that a magnetic field 12, which can enter the window 10 through the transmission coil 13 of an RF reader (which is otherwise not illustrated in any further detail) and can stimulate the coil 4 [lacuna], so that the chip 3 of the transponder 2 can be read and can also be written to, as is indicated in FIG. 4.

The transponder 2 is introduced in the manner according to the invention into the hole 8 in the metal body 9, as follows:

First of all, as a first step, the coil 4 is wound on the ferrite core 5 and is electrically connected at its ends to the two electrical connections 3a, 3b of the chip 3, forming the transponder 2.

The transponder 2 formed in this way is then introduced into the sleeve 7, where it is positioned such that the longitudinal axis of the ferrite core 5 is aligned approximately parallel to the longitudinal axis of the sleeve 7. The transponder 2 is fixed in this position by encapsulating the sleeve 7 with the elastic material 6.

The transponder module 1 formed in this way is introduced into the elongated hole 8 in the metal body 9 and is positioned such that, firstly, the longitudinal axis of the sleeve 7 and hence also the longitudinal axis of the coil 4 are aligned parallel to the surface 9a of the metal body 9 and, secondly, such that the coil 4 is positioned directly under the window 10 in the metal body 9. The transponder module 1 is then fixed in the hole 8 by filling the hole 8 with the encapsulation material 11.

1. Method for fitting a transponder (2) with a chip (3) and a coil (4) to a metal body (9), characterized in that
the coil (4) is wound in the form of a bar and is electrically connected at its ends to the electrical connections (3a, 3b) of the chip (3), forming a transponder (2), and
the transponder (2) formed in this way is introduced in its entirety into a cavity (8) in the metal body (9) in such a manner that the coil axis (X) lies parallel to the metal surface, and at least part of the coil (4) is positioned in the region of a window (10) in the metal body (9).

2. Method according to claim 1, characterized in that the cavity (8) is a groove in the surface of the metal body (9).

3. Method according to claim 1, characterized in that the transponder (2) is introduced into the cavity (8) in such a manner that it is essentially completely surrounded by metal except for the region of the window (10).

4. Method according to claim 3, characterized in that the transponder (2) is introduced into a hole (8), which runs parallel to the surface of the metal body (9), as a cavity.

5. Method according to claim 3, characterized in that the window (10) in whose region the coil (4) is positioned is smaller than the transponder (2).

6. Method according to claim 5, characterized in that the window (10) has a shorter length and/or a narrower width than the coil (4) of the transponder (2).

7. Method according to (one of the preceding claims) claim 1, characterized in that the transponder (2) is embedded in an elastic material (6) forming a transponder module (1) before being introduced into the cavity (8) in the metal body (9).

8. Method according to claim 7, characterized in that a soft plastic material, in particular silicone or polyurethane, is used as the elastic material (6).

9. Method according to claim 7, characterized in that the transponder is introduced into a sleeve (7) composed of a non-metallic material, in particular composed of glass or plastic.

10. Method according to claim 9, characterized in that the sleeve (7) is filled with the elastic material (6) once the transponder (2) has been introduced.

11. Method according to claim 9, characterized in that the sleeve (7) is tubular and the transponder (2) is introduced into the sleeve (7) such that the coil axis runs parallel to the tube axis.

12. Method according to one of the preceding claims, characterized in that the cavity (8) in the metal body (9) is encapsulated with a non-metallic elastic material (11) once the transponder (2) has been introduced.

13. Method according to claim 12, characterized in that a plastic material, in particular an epoxy resin, is used as the encapsulation material (11).

14. Method according to claim 13, characterized in that the encapsulation material (11) is harder than the elastic material (6) in which the transponder (2) is embedded.

15. Method according to claim 1, characterized in that the coil (4) is wound on a ferrite core.

16. Transponder module having a transponder (2) which has a chip (3) and a coil (4) which is electrically connected to it, and is embedded in an elastic material (6), characterized in that the coil (4) is wound in the form of a bar, the transponder (2) is introduced into a sleeve (7) which is, in particular, tubular, and the sleeve (7) is filled with the elastic material (6).

17. Transponder module according to claim 16, characterized in that the tubular sleeve (7) is open at its' axial ends.

18. Transponder module according to claim 16, characterized in that the tubular sleeve (7) is closed at at least one axial end.

19. Transponder module according to claim 16, characterized in that the coil (4), which is in the form of a rod is wound on a ferrite core (5).

20. Transponder module according to claim 16, characterized in that the coil (4), which is in the form of a rod, is aligned parallel to the longitudinal axis of the sleeve (7).
